(19) United States
(12) Patent Application Publication
(10) Pub. No.: US 2008/0154721 A1
(43) Pub. Date: Jun. 26, 2008

(54) Method and Device for Automatically Accepting and Franking Mailpieces

(76) Inventors: Hans Schneider, Kroppach (DE); Matthias Rakow, Berlin (DE)

Correspondence Address: International IP Law Group, P.O. BOX 691927, HOUSTON, TX, 77269-1927, US

(21) Appl. No.: 11/884,085

(22) PCT Filed: Mar. 21, 2005
(86) PCT No.: PCT/EP05/02985

§ 371 Date: Feb. 2, 2008

(30) Foreign Application Priority Data
Feb. 9, 2005 (DE) 10 2005 006 005.6

(51) Int. Cl. G07B 17/02; G06Q 30/00

(52) U.S. Cl. 705/14; 705/410; 705/408

(57) ABSTRACT

An exemplary method for accepting and franking mailpieces is disclosed. The exemplary method comprises accepting a mailpiece into a housing of the device, the housing being inaccessible to customers. The method further comprises determining a measured value for a weight Wt of the mailpiece and determining measured values for a length L, a width W and a thickness T of the mailpiece. The method additionally comprises adding amounts corresponding to negative tolerances for each of the measured values in order to generate adjusted measured values Wt′, L′, W′ and T′ and subtracting amounts corresponding to positive tolerances for each of the measured values in order to generate the adjusted measured values Wt″, L″, W″ and T″. The method additionally comprises comparing the adjusted measured values to value ranges from a reference list, the reference list associating different postage amounts with value ranges of the adjusted measured values, generating a result list with postage amounts that are associated with the determined adjusted measured values and determining a lowest postage amount of the result list. The exemplary method further comprises specifying the lowest postage amount as a postage amount of the mailpiece, applying a postage indicium corresponding to the postage amount of the mailpiece to the mailpiece and storing the mailpiece in the housing of the device when the postage indicium has been applied onto the mailpiece.

### CROSS REFERENCE TO RELATED APPLICATIONS

Pursuant to 35 U.S.C. § 371, this application is the United States National Stage Application of International Patent Application No. PCT/EP2005/002985, filed on Mar. 21, 2005, the contents of which are incorporated by reference as if set forth in their entirety herein, which claims priority to German (DE) Patent Application No. 10 2005 006 005.6, filed Feb. 9, 2005, the contents of which are incorporated by reference as if set forth in their entirety herein.

### BACKGROUND

The invention relates to a method for accepting and franking mailpieces. The invention also relates to a device for carrying out this method.

In addition to applying postage indicia such as postage stamps, it is known in the realm of franking mailpieces to use franking machines that can be employed by a user to provide large volumes of mail with postage indicia. However, especially customers who have small or irregular volumes of mailpieces to be franked tend to avoid acquiring a franking machine.

Moreover, customers can drop off a large volume of unfranked mailpieces at a branch office of a transportation and delivery service provider. The delivery company franks the mailpieces, likewise making use of franking machines. However, the customers are limited to the opening hours of the branch offices of the delivery company when they want to drop off their mailings.

Therefore, in the postal service realm, there is a need for a drop-off station for mailpieces where large volumes of unfranked mailpieces can be dropped off, whereby the device automatically franks the mailings. The device could be set up in public areas so as to ensure 24-hour access for customers. Such a device presupposes a method for automatically determining the postage amount needed for the mailing in question.

### SUMMARY OF THE INVENTION

Therefore, the objective of the invention is to provide a method for accepting and franking mailpieces that makes it possible to accept mailings in a collecting device, to automatically determine the postage amounts and to frank the mailpieces with postage indicia.

The objective of the invention is also to provide a device to carry out this method. In particular, it should be a device that can be calibrated.

The method according to the invention for accepting and franking mailpieces in a device entails several steps for automatically determining the postage amount for a mailing. A receiving means transfers the dropped-off mailpiece into a housing that is not accessible to customers. Inside the device, scales determine the weight Wt of the mailpiece. Then measured values pertaining to the length L, width W and thickness T of the mailpiece are each determined by means of an appropriate measuring instrument. The tolerances for each of these measuring instruments are available to a computing means inside the device and the ascertained measured values are increased or decreased by these tolerances.

In the computing means, the amounts of the negative tolerances of the individual measuring instruments are added to each of the determined measured values in order to generate the adjusted measured values Wt¹, L′, W and T¹. Moreover, the amounts of the positive tolerances are subtracted in order to generate the adjusted measured values Wt″, L″, W″ and T″. These adjusted measured values are compared to value ranges of a reference list, whereby the reference list associates different postage amounts with value ranges of the adjusted measured values. On the basis of the comparison, a result list is generated with postage amounts that are associated with the determined adjusted measured values. Then the lowest postage amount of the result list is determined and this value is specified as the postage amount of the mailpiece. Finally, a postage indicium is printed onto the mailpiece, whereby this postage indicium corresponds to the determined postage amount. A receipt can be issued to the customer confirming the drop-off and the execution of the franking of the mailpieces.

In an embodiment of the invention, no postage indicium is applied and the mailpiece is ejected from the device if it could not be associated with a product and if the result list is consequently empty. Once a postage indicium has been applied onto the mailpiece, the mailpiece is stored in the housing of the device.

In an especially preferred embodiment of the invention, the reference list for each of the different types of mailpieces contains an association of postage amounts with value ranges of the adjusted measured values. The information about the type of mailpiece can comprise, for example, data on the content, on the mailing destination and/or on additional services and this can be indicated by the customer. On the basis of the information about the type of mailpiece, a result list is generated with postage amounts that are associated with the determined adjusted measured values and with the indicated type of mailpiece.

In another embodiment of the invention, the computing means determines a quotient LVW″ from the length L′ increased by the negative tolerance and from the width W″ decreased by the positive tolerance. The reference list also associates corresponding postage amounts with value ranges of the adjusted measured values and the quotient VfW″. On the basis of the determined quotient and the adjusted measured values, a result list is generated with postage amounts that are associated with the determined adjusted measured values and with the quotient LVW″.

The method also comprises invoicing a customer for the postage amount applied onto the mailpiece. Preferably, for this purpose, before the mailpiece is placed into the device, a registered customer is identified and the postage amount applied onto the mailpiece is invoiced on the basis of this identification. The access to functions of the device is preferably only released for customers who have been previously identified at the device as being authorized. The method can also provide that a personalized advertising message can be read into the device and then printed onto the mailpiece together with a postage indicium.

The invention also comprises a device for accepting and franking mailpieces. The device comprises appropriate means for carrying out the method according to the invention. It especially comprises a receiving means for transferring a mailpiece into a housing that is not accessible to customers, whereby the receiving means is preferably a sorting machine. The device also has means for reading in a file with the reference list and means for reading in and checking a customer identification. The device preferably comprises means for invoicing a postage amount printed onto a mailpiece for a registered customer as well as means for reading in and printing an advertising message.

The method according to the invention and the appertaining device have the advantage that they offer customers the flexible capability to deliver and frank mailpieces. Since the device can be installed in public places and operated 24 hours per day, customers are not limited to the opening hours of branch offices. Even without franking machines of their own, customers can provide large volumes of mail with postage indicia without having to glue stamps onto the mailpieces. Additional functions such as the acceptance of registered letters or the sale of postage stamps could be integrated into the drop-off station. Moreover, forms that would otherwise only be available at branch offices can be issued by the device.

The method according to the invention for determining the postage also has the advantage that the appertaining drop-off station is a device that can be calibrated. The entire method, including the algorithm for determining the postage, can be calibrated, whereby especially the computer-aided postage determination with the electronic transmission of the reference list can be calibrated. Thanks to this ability to be calibrated, a device can be provided that can be installed in public areas so that mailpieces can be franked automatically. Here, the adaptation of the measured values on the basis of the tolerances of the measuring instruments and the selection of the lowest determined postage amount ensures that customers are not overcharged.

### BRIEF DESCRIPTION OF THE DRAWING

The figure shows the following:

FIG. 1 is a block diagram of a device for accepting and franking mailpieces in accordance with an exemplary embodiment of the present invention.

### DETAILED DESCRIPTION OF SPECIFIC EMBODIMENTS

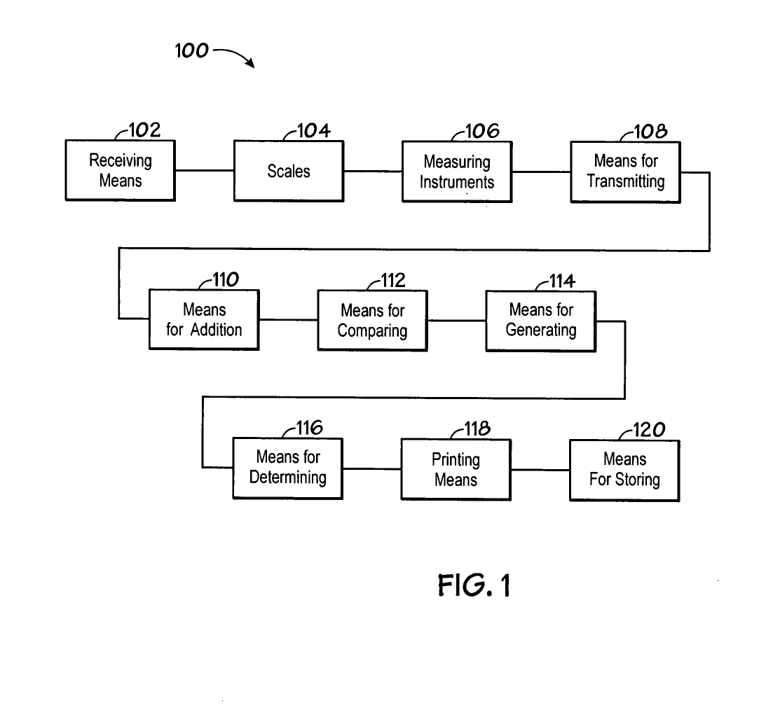

FIG. 1 is a block diagram of a device for accepting and franking mailpieces in accordance with an exemplary embodiment of the present invention. The accepting and franking device is generally referred to by the reference number 100. As set forth in detail below, the accepting and franking device 100 comprises a receiving means 102, scales 104, measuring instruments 106 for determining a measured value for various dimensions of a mailpiece. The accepting and franking device 100 also includes means 108 for transmitting the measured values of the mailpiece to a processor.

A means 110 for addition of amounts of negative tolerances of each of the measured dimensions determines adjusted measured values. A means 112 for comparing compares the adjusted measured values measured values from a reference list. A means 114 for generating a result list provides postage amounts that are associated with the determined adjusted measured values. Also included in the exemplary accepting and franking device 100 is a means 116 for determining a lowest postage amount of the result list and a printing means 118 for applying a postage indicium onto the mailpiece. Finally, the accepting and franking device 100 comprises a means 120 for storing the mailpiece in the housing of the device.

In a preferred embodiment of the invention, the method according to the invention is carried out in a device that will also be referred to below as the drop-off station. The device 100 has a housing that is not accessible to customers. In this context, the term customer is used to refer to a person who drops off mailpieces at the device so that they can be franked. As soon as the customers have placed the mailpieces into the device 100, they no longer have the possibility to access the mailpieces. The device 100, however, is accessible to service personnel who have access to the various technical components. For this purpose, one or more lockable doors can be provided that allow access to the technical components of the device. The device 100 is also accessible to personnel of the operator of the device 100; they remove dropped-off mailpieces and convey them to the transportation and delivery process.

For the pick-up and the subsequent transportation, the dropped-off mailpieces are preferably collected in a container that is likewise accessible through a lockable door. The container is, for example, a mailbag that can be hung in the device in such a way that the franked mailings are collected in it. The filled mailbag can be removed and replaced with an empty bag. However, the collecting container can also comprise other replaceable containers such as boxes. In another embodiment, the mailpieces are collected inside the device and are filled into a separate container when an employee comes to pick them up. With all of the variants, it can be provided that the device checks the filling level of the collecting container in question. If the collecting container is filled to a predefinable level, then the operator of the device is notified that it has to be emptied. Moreover, the device can refuse to accept additional mailings.

The device is advantageously configured burglar-proof and weather-proof so that it can be used outdoors. It is preferably set up in public places so as to ensure 24-hour operation. In this manner, the customer can drop off mailings at any time without having to take the opening hours of branch offices into account.

The device 100 has a receiving means 102 for accepting mailpieces. This is preferably a sorting machine that individually feeds a stack of mailpieces into the device. The sorting machine can be a device which allows an individual feed as known from the state of the art. The customer places a stack of mailpieces, for example, into a receiving opening and closes a covering door behind which the mailpieces are fed in. Individual mailpieces can likewise be accepted into the device via the feed mechanism. The device can also have a slot like in conventional mailboxes for inserting individual mailpieces.

The device can preferably accept franked as well as unfranked mailpieces. In an embodiment of the invention, the device is configured in such a way that it cannot differentiate between these two types of mailpieces. In this case, the customer is requested to deposit franked or unfranked mailpieces and to indicate the type of mailpieces in question. If the device has means for differentiating between unfranked and franked mailpieces, the customer can deposit mixed types of mail. The differentiation between unfranked and franked mailpieces can be made, for example, by evaluating graphic information on the surface of the mailpieces.

In an especially preferred embodiment of the invention, the orientation of the mailpieces as well as graphic information on the mailpieces are detected inside the device and the mailpieces are rotated and turned on the basis of the evaluation of this information so that a correctly positioned postage indicium can be printed onto one side. The graphic information is address and/or sender information that is evaluated on the basis of a predefined paradigm. In another embodiment of the invention, there are printing means 118 positioned at both sides of the mailpieces so that, on the basis of the detected graphic information, the intended printing side of a mailpiece is determined and the appropriate printing means is actuated only on this side.

Moreover, the device 100 can require the customer to insert the mailpieces into the device 100 in a certain orientation. For example, if the mailpiece has to be inserted in an orientation in which the address field is facing upwards, then the graphic information present on the mailpiece is evaluated to this effect and a mailpiece is ejected again if it was inserted incorrectly. The orientation of a mailpiece can be recognized, for example, in that a digital camera acquires an image of the mailpiece. The image is taken one line at a time at a fixed distance and fixed focal distance, and subsequently combined to form a complete image. With this image and a comparison with previously defined dimensions of the address zone of different letter formats, the image evaluation recognizes whether an address is present in the address zone provided for this purpose. If no address is recognized there, the mailpiece has been placed incorrectly and is removed from further processing. An analogous procedure can be carried out if mailpieces are inserted upright rather than crosswise.

After mailpieces have been sorted, each one is moved through the device by means of one or more transport means. These transport means are, for example, conveyor belts and rollers that feed a mailpiece through various measuring instruments and subsequently through a printing arrangement. The mailpieces are preferably transported upright. The various measuring instruments determine at least the weight and the dimensions of the mailpiece and the individual instruments can preferably be calibrated. The individual measured values can be determined either consecutively or else simultaneously by different measuring instruments 106.

The weight Wt of a mailpiece can be measured by various weighing methods. In an especially preferred embodiment of the invention, the weight is determined by means of dynamic scales 104 having a strain gauge. The scales 104 are calibrated and the minimum and maximum tolerance values are determined. The tolerance values can be obtained from the technical data of the scales 104 being used or by performing a series of readings. The tolerance values are stored in a computing means of the device. The tolerance values can be provided, for example, in a changeable file.

The length of a mailpiece can likewise be determined by various known means. Here, the length L is defined as the greatest distance of two edges of a mailpiece from each other. In an especially preferred embodiment of the invention, the length of a mailpiece is determined by a running roller with a defined contact pressure. An angle pick-up is attached to the axis of the running roller and the pulses of the angle pick-up are counted as long as the mailpiece is located under the roller. The maximum and minimum tolerance values of this measurement can be obtained by evaluating a series of readings, whereas a calibration is not absolutely necessary.

The thickness T of a mailpiece is measured, for example, by a spring that presses a pressure roller with a defined contact pressure against the mailpiece as it is passing through. The pressure roller is connected via a rigid lever to a measured value pick-up in which a lever movement pushes a film with stripes through a light barrier. The light barrier counts the pushed-through stripes and converts them proportionally into a thickness. The maximum value determined for the thickness of a mailpiece is then assumed to be the thickness of the entire mailpiece. This arrangement for thickness measurement does not absolutely have to be calibrated and the tolerance values can be determined from a series of readings.

The measurement of the width W of a mailpiece is carried out, for example, by means of image recognition or by permanently installed width-measuring sensors. Here, the width W is defined as the smallest distance of two opposing edges of a mailpiece from each other. The measurement via an image can be calculated with sufficient precision by means of triangular functions from the focal distance, from the image format during acquisition and from the distance. Here, appropriate methods for calibrating the measuring instruments 106 are needed. When the sensor system is permanently installed, the precision is defined by the installation site and calibration is not absolutely necessary. The tolerance values of the measuring instrument can likewise be determined by means of a series of readings.

The various measuring instruments 106 are connected to a computing means that is preferably likewise inside the device. When a mailpiece passes through the various measuring instruments, the obtained measured values are transferred to the computing means for evaluation purposes. In order to evaluate the measured values, the computing means contains data about the negative and positive tolerances of the individual measuring instruments. In a first step, these tolerances are computed together with the determined measured values T for the thickness, L for the length, Wt for the weight and W for the width of the mailpiece. In each case, the amount of the negative tolerance is added to the measured value in order to obtain adjusted measured values T′, L′, Wt′ and W. Moreover, the amount of the positive tolerance is subtracted from the measured value in order to obtain adjusted measured values T″, L″, Wt″ and W″.

If the instrument for the length measurement has, for example, a tolerance of +2 mm and −3 mm, then the negative tolerance of 3 mm is added to a measured length L=236 mm, resulting in an adjusted measured value of L′=239 mm. Furthermore, the positive tolerance of 2 mm is subtracted from the measured length value, thus resulting in an adjusted measured value of L″=234 mm. The adjusted measured values of the other parameters are computed analogously in the computing means. In an especially preferred embodiment of the invention, a quotient LVW″ is determined from the length L′ that has been increased by the negative tolerance and from the width B″ that has been decreased by the positive tolerance.

A reference list can be read into the computing means, said list comprising at least an association of postage amounts with value ranges of the adjusted measured values. The reference list is preferably available to the computing means as a file that can be changed. Thus, postage amounts can be augmented or changed flexibly. The reference list is structured, for example, as shown in Table 1.

TABLE 1

| | | Tₘᵢₙ | Tₘₐₓ | Lₘᵢₙ | Lₘₐₓ | Wₘᵢₙ | Wₘₐₓ | Wtₘᵢₙ | Wtₘₐₓ | | |
|---|---|---|---|---|---|---|---|---|---|---|---|
| Product | Format | [mm] | [mm] | [mm] | [mm] | [g] | [g] | [g] | [g] | L/W | Postage |
| Letter | Standard | 0 | 5 | 140 | 235 | 90 | 125 | 0 | 20 | 1.41 | .55 |
| Letter | Compact | 0 | 10 | 100 | 235 | 70 | 125 | 0 | 50 | 1.41 | 1.00 |
| Letter | Large | 0 | 20 | 100 | 235 | 70 | 125 | 0 | 500 | 0 | 1.44 |

On the basis of the determined adjusted measured values T¹, T″, L¹, L″, Wt′, Wt″, W and W″, the computing means compares the adjusted measured values to the value ranges of the reference list. Here, the comparison can be augmented by a comparison of the quotient L/B″ with the quotients of the list. When a product or a product class is determined in whose associated value ranges all of the adjusted measured values lie, then the associated postage amount is entered into a result list. If the result list contains several postage amounts, the smallest amount is determined and established as the postage amount that has to be applied to the mailpiece. If the result list contains only one entry, then the appropriate postage amount is determined as being the postage amount to be applied. On the basis of the postage amount thus determined, a postage indicium is generated and printed onto the mailpiece.

In an especially preferred embodiment of the invention, the product class associated with the postage amount is likewise applied onto the mailpiece. If, on the basis of the measurements, it was ascertained, for example, that it is a compact letter, then this information is printed onto the mailpiece together with the postage indicium. The imprint can be applied in plain text and/or in encrypted form. Special preference is given to applying it in plain text since this allows customers to see which product class the device has ascertained and for which product class they will be invoiced. This embodiment of the invention is especially conducive to the calibration of the method and of the device when the product class is applied onto the mailpiece in a form that can be accepted for official documents. This can be achieved, for example, by using ink that is accepted for official documents.

If the result list is empty, then no product class was determined on the basis of the measurements and the mailpiece cannot be accepted by the device. In this case, a message to this effect is shown to the user by means of a display of the device and the mailpiece is ejected from the device.

In another embodiment of the invention, the postage amount is determined on the basis of information provided by a user about the type of mailing, and this then constitutes a semi-automatic postage determination procedure. The type of mailing can comprise, for example, information about the content, destination or additional services. In an embodiment of the invention, this information is not determined physically but rather entered by the user via an entry means on the device.

For example, a user indicates whether the destination of the mailpiece is domestic or international. This can also be done automatically through an evaluation of the address on the mailpiece, but since a manual evaluation is needed in case of illegible addresses, it can be provided that the destination is fundamentally entered by the user. Here, it is advantageous that the user does not indicate the differentiation between domestic and international mailings for each mailpiece individually, but rather for a larger number of dropped-off mailpieces at once.

The user can also provide information on the content of the mailpiece since, for example, a mailing containing goods or books, an information letter with advertising content or a mail delivery order require different postage amounts from a standard letter mailing. This content information can be checked, for example, on a random basis during the subsequent transportation and delivery process.

The user can also select an additional service such as, for example, registered letter, which likewise changes the postage amount to be determined. In this process, the reference list can take into account the fact that different additional services are only permissible, for example, for certain formats. The device can be appropriately configured to accept registered letters. For this purpose, an image of the address can be taken inside the device. The image can be displayed to customers on a monitor so that they can manually enter a sender and/or recipient address relating to the address image. The address is stored together with the image and a receipt is printed out confirming that the customer has deposited the registered letter, in addition to the sender and the recipient of the mailpiece, the receipt also contains the date of the drop-off. Moreover, it can be provided that the image of the mailpiece is likewise printed on the receipt.

The function of the registered letter can preferably also be selected for already franked mailpieces. In another embodiment of the invention, images of the mailpieces are generated not only for registered letters, but also for normal letters. For example, a user can request the generation of a drop-off receipt for one or more mailpieces.

The postage indicium with the determined postage amount is generated by the device and can have various forms known from the state of the art. For example, it can be a graphic encryption of the postage amount in which additional information such as the sender, the recipient or the date of the generation of the postage indicium is encrypted. Moreover, an identification of the device can be encrypted in the postage indicium.

In another especially preferred embodiment of the invention, the customer can print personalized advertising messages onto a mailpiece together with a postage indicium. Various methods are possible for reading in the design of the advertising message. For example, the customer can insert into the device a storage medium on which the advertising message is stored. This storage medium can be, for example, a floppy disk or a CD-ROM. The storage medium can contain multiple advertising messages stored on it, from which the customer can make a selection.

In another embodiment of the invention, one or more advertising messages of the customer can be stored prior to depositing mailpieces. The advertising messages are stored in a central administration unit, for example, under a customer identification, and can be retrieved by the customer at any drop-off station. In this case, the advertising messages are stored, for instance, on a central server. When a customer identifies himself at a drop-off station, the available advertising messages are determined on the basis of the customer identification. The customer selects an advertising imprint that is downloaded from the server onto the device. The advertising imprint is then printed onto one or more mailpieces, together with a postage indicium.

The postage amounts of a franking procedure carried out by the device can be invoiced in different ways. Preferably, a customer identifies himself prior to dropping off mailpieces at the device. This can be done, for example, by inserting a customer card and/or by entering a PIN (personal identification number). In an embodiment of the invention, the functions of the device are only accessible to customers once they have successfully identified themselves. On the basis of the identification, a customer is either invoiced for a postage amount to be paid or else the amount is debited from a customer account. The customer account can be the general account of the customer from which the operator of the device has authorization to withdraw funds. It can also be a special customer account that has been set up with the operator of the device and that is regularly filled up with a credit balance by the customer. In the latter case, it can be provided that, during the identification process, it is checked whether the customer has a sufficient credit balance in his customer account. If not, the device can refuse to accept the mailpieces. The credit balance can be checked, for example, via a connection between the device and a central administration unit.

The device can also have compartments for issuing or removing transportation containers. If a customer drops off a large number of mailpieces at the device, then the operator of the drop-off station provides him with transportation containers with which he can transport the mailpieces to the station. Such containers can be placed into compartments of the device so that customers do not have to take the containers back with them. The customer can also take additional containers out of the compartments. In another embodiment of the invention, the compartments can also be used to deposit containers with several mailpieces that have already been franked. It is also possible to deposit containers with unfranked mailpieces that are not to be franked by the device but rather by a subsequent franking procedure by the operator of the device. In the latter two cases, the device merely serves as a receiving device. The access to the compartments is preferably coupled to a successful identification of the customer at the device, whereby a compartment cannot be opened again after a container with mailpieces has been deposited.

In another embodiment, the drop-off station is combined with an automatic machine for dispensing stamps so that a customer can preferably purchase postage stamps of any value at the device. The postage stamps can be paid for by depositing money, by using a money card or likewise via the customer card that is needed for gaming access to the device. In addition to postage stamps, forms or other documents that are normally available at a branch office can also be issued.

Moreover, the device makes it possible to take into account postage discounts, for example, for certain numbers of mailpieces or for presorted volumes of mail. Preferably, the device has means to monitor and administer all operating data so that especially error messages can be transmitted to a remote central monitoring system. In particular, the reference lists with product-postage associations are entered via a central administration unit. Furthermore, all drop-off procedures can be logged with an association with the customer identification. Via the central system, the device can also be supplied with information about customers for whom acceptance of mailpieces was refused for security reasons.

1-20. (canceled)

21. A method for accepting and franking mailpieces, the method comprising:
accepting a mailpiece into a housing of the device, the housing being inaccessible to customers;
determining a measured value for a weight Wt of the mailpiece;
determining measured values for a length L, a width W and a thickness T of the mailpiece;
adding amounts corresponding to negative tolerances for each of the measured values in order to generate adjusted measured values Wt′, L′, W′ and T′;
subtracting amounts corresponding to positive tolerances for each of the measured values in order to generate the adjusted measured values Wt″, L″, W″ and T″;
comparing the adjusted measured values to value ranges from a reference list, the reference list associating different postage amounts with value ranges of the adjusted measured values;
generating a result list with postage amounts that are associated with the determined adjusted measured values;
determining a lowest postage amount of the result list;
specifying the lowest postage amount as a postage amount of the mailpiece;
applying a postage indicium corresponding to the postage amount of the mailpiece to the mailpiece; and
storing the mailpiece in the housing of the device when the postage indicium has been applied onto the mailpiece.

22. The method according to claim 21, wherein the postage indicium contains information on a product class of the mailpiece, the determined postage amount being associated with the product class.

23. The method according to claim 22, wherein the information about the product class of the mailpiece is contained in plain text and/or encrypted in the postage indicium.

24. The method according to claim 21, comprising ejecting the mailpiece from the device prior to application of the postage indicium if the result list is empty.

25. The method according to claim 21, comprising:
generating a reference list for each of a plurality of different types of mailpieces, the reference list containing an association of postage amounts with value ranges of adjusted measured values; and
generating a result list on the basis of information about a type of mailpiece, wherein postage amounts are associated with the determined adjusted measured values and with the indicated type of mailpiece.

26. The method according to claim 25, wherein the information about the type of mailpiece comprises data on the content, mailing destination and/or additional services to be performed regarding the mailpiece.

27. The method according to claim 21, comprising:
determining a quotient L′/W″ from the length L′ increased by the negative tolerance and from the width W″ decreased by the positive tolerance, the reference list associating corresponding postage amounts with value ranges of the adjusted measured values and with the quotient L′/W″; and
generating a result list on the basis of the determined quotient and of the adjusted measured values, wherein postage amounts are associated with the determined adjusted measured values and with the quotient L′/W″.

28. The method according to claim 21, comprising invoicing a customer for the postage amount applied onto the mailpiece.

29. The method according to claim 28, comprising identifying a registered customer before the mailpiece is placed into the device, the invoicing of the postage amount applied onto the mailpiece being done on the basis of the identification.

30. The method according to claim 21, wherein access to functions of the device is only provided for customers previously identified as being authorized to access the device.

31. The method according to claim 21, comprising printing a personalized advertising message onto the mailpiece.

32. A device for accepting and franking mailpieces, the device comprising:
a receiving portion that transfers a mailpiece into a housing that is not accessible to customers;
a scale that determines a measured value for a weight Wt of the mailpiece;
measuring instruments that determine measured values for a length L, a width W and a thickness T of the mailpiece;
a processor that receives the measured values Wt, L, W and T, the processor having access to negative and positive tolerance values for the measured values Wt, L, W and T, the processor adding amounts corresponding to negative tolerances for each of the measured values in order to generate adjusted measured values Wt′, L′, W′ and T′, the processor subtracting amounts corresponding to positive tolerances for each of the measured values in order to generate the adjusted measured values Wt″, L″, W″ and T″;
a comparator that compares the adjusted measured values to value ranges from a reference list, the reference list associating different postage amounts with value ranges of the adjusted measured values;
a result list generator that generates a result list having postage amounts that are associated with the determined adjusted measured values;
a postage amount generator that determines a lowest postage amount of the result list;
a printer that is adapted to print a postage indicium corresponding to the lowest postage amount onto the mailpiece; and
a housing that stored the mailpiece once the postage indicium has been applied onto the mailpiece.

33. The device according to claim 32, wherein the processor determines a product class of the mailpiece, the product class being associated with the lowest postage amount, and wherein the printer prints the product class onto the mailpiece.

34. The device according to claim 33, wherein the product class is printed onto the mailpiece in a form that can be accepted for official documents.

35. The device according to claim 32, the receiving portion comprises a sorting machine.

36. The device according to claim 33, comprising an input device that reads in a file with the reference list.

37. The device according to claim 33, comprising a reader that reads in and checks a customer identification.

38. The device according to claim 33, wherein the device is adapted to provide an invoice for a postage amount to a registered customer.

39. The device according to claim 33, wherein an advertising message is printed onto the mailpiece.

40. A device for accepting and franking mailpieces, the device comprising:
means for accepting a mailpiece into a housing of the device, the housing being inaccessible to customers;
means for determining a measured value for a weight Wt of the mailpiece;
means for determining measured values for a length L, a width W and a thickness T of the mailpiece;
means for adding amounts corresponding to negative tolerances for each of the measured values in order to generate adjusted measured values Wt′, L′, W′ and T′;
means for subtracting amounts corresponding to positive tolerances for each of the measured values in order to generate the adjusted measured values Wt″, L″, W″ and T″;
means for comparing the adjusted measured values to value ranges from a reference list, the reference list associating different postage amounts with value ranges of the adjusted measured values;
means for generating a result list with postage amounts that are associated with the determined adjusted measured values;
means for determining a lowest postage amount of the result list;
means for specifying the lowest postage amount as a postage amount of the mailpiece;
means for applying a postage indicium corresponding to the postage amount of the mailpiece to the mailpiece; and
means for storing the mailpiece in the housing of the device when the postage indicium has been applied onto the mailpiece.
